(19) United States
(12) Patent Application Publication
(10) Pub. No.: US 2009/0165629 A1
(43) Pub. Date: Jul. 2, 2009

(54) DEVICES AND METHODS TO ASSIST IN PLAYING A PIANO

(76) Inventor: Tolga Timuray, Ridgefield, NJ (US)

Correspondence Address: BOOTH UDALL, PLC, 1155 W. Rio Salado Pkwy., Suite 101, Tempe, AZ, 85281, US

(21) Appl. No.: 11/966,508

(22) Filed: Dec. 28, 2007

(51) Int. Cl. G10C 3/26; G10C 3/00

(52) U.S. Cl. 84/220; 84/229

(57) ABSTRACT

An adjustable pedal extension device for a piano and methods for use. An adjustable clamp member is configured couple to a piano pedal. A pedal extension member is adjustably coupled to a clamp member for horizontal movement of at least one end of the pedal extension. An adjustable member is configured to selectively fix the pedal extension into a fixed position in relation to the clamp member after adjustment is made. A piano muffler kit includes a sound effect pad comprising at least one sound effect layer. A muffler rail dampening element is coupled to a piano in the engagement path of a muffler rail.

### BACKGROUND

1. Technical Field

Aspects of this document relate generally to devices for pianos.

2. Background Art

The piano is a well-known musical instrument in which a plurality of hammers, each associated with and operated by a piano key through an assembly known as an action, strike upon piano strings to create musical tones, notes or sounds. There exist many different piano configurations. For example, grand piano configurations include harp-shaped bodies and have their strings oriented horizontally. Conventional grand pianos may include concert grands, parlor grands and baby grands, for example. In contrast to grand piano configurations, upright pianos conventionally include a generally rectangular body or frame and have their strings oriented vertically. Conventional upright pianos may include spinets, consoles, studios, professional uprights as well as all other designs where the strings are oriented vertically.

Conventional pianos have a plurality of strings mounted within a frame. The plurality of strings are typically arranged into collections of one, two or three adjacent strings. These collections are conventionally known as unisons. Single-string unisons of comparatively long strings are typically located at the far left of the piano and produce comparatively very low tones, notes or sounds. Shorter two-string unisons are located to the right of the single-string unisons and are typically used to produce tones, notes and sounds that are comparatively higher than the single-string unisons, but comparatively lower than the strings located to the right of the two-string unisons. Even shorter three-string unisons are typically located to the right of the two-string unisons and are used to produce tones, notes and sounds that are comparatively higher than the unisons located to the left.

Conventional pianos include a muffler pad coupled to a muffler rail. While specific configurations may differ, the muffler rail typically operates in conjunction with one or more muffler rail engagement elements that are operationally coupled to a piano pedal, hand lever, or other actuation device by one or more one or more intermediate linkages. Such muffler rail engagement elements may be located on one or more sides of a muffler rail. In those piano designs that employ only a single muffler rail engagement element, perceptible vibration may occur upon the activation of the muffler rail since the side of the muffler rail without a muffler rail engagement element may bounce or otherwise cause audible vibration when forcefully engaged.

Conventionally, it is the middle pedal of upright pianos that has been operationally coupled to the muffler rail, although in theory the muffler rail could be operationally coupled to any one of the piano pedals. In grand pianos, the muffler rail may be operationally coupled to a hand-lever or other actuation device. During normal piano performance, the muffler rail is maintained in a standby position clear of the strings and associated hammers of a piano so that no muffling effect occurs.

Conventionally, in upright pianos, when a piano pedal operationally coupled to a muffler rail is depressed by a user, the muffler rail may be engaged between the hammers and associated strings. In grand pianos, when a hand-lever or other actuation device operationally coupled to a muffler rail is engaged by a user, the muffler rail may be engaged between the hammers and associated strings. When the muffler rail is engaged, whether in an upright or a grand piano, the muffler pad coupled to the muffler rail may become interposed between the strings and associated hammers of a piano. The interposition of the muffler pad between the strings and associated hammers muffles a considerable amount of the force with which a hammer strikes a string when a piano key is depressed, thereby reducing the volume resulting from the piano keystrike. Since the hammer strikes the string indirectly via the muffler pad when the muffler rail is engaged, the tone quality is softened. Thus, with the muffler rail engaged in conventional designs, hard tone, which is the normal piano tone characteristic, is elusive.

Conventionally, the further a piano pedal operationally coupled to a muffler rail is depressed by a user (in the case of upright pianos) or the further a hand-lever or other actuation device operationally coupled to a muffler rail is engaged (in the case of grand pianos), the further the muffler rail will be engaged. The further the muffler rail is engaged, the greater the portion of the muffler pad that may be interposed between the hammers and the strings. It will be understood that the specific engagement of a muffler rail may vary according to the specific manner of engagement, and the specific configuration of the one or more intermediate linkages operationally coupling the muffler rail to a piano pedal.

Conventionally, in order to engage two piano pedals simultaneously, a player pushes two pedals with two feet. Players with large or wide feet, and novice or uncoordinated players, may find it difficult to simultaneously engage two piano pedals with two feet due to the closeness of the piano pedals to one another. Alternatively, a player desiring to engage two piano pedals simultaneously may attempt to engage two pedals with a single foot. Nevertheless, the close proximity of piano pedals to one another makes simultaneous engagement of two piano pedals awkward for many players.

### SUMMARY

Aspects of this invention relate to devices for pianos.

In one aspect, an adjustable pedal extension device for a multiple pedal piano comprises an adjustable clamp member configured to receive and couple to a piano pedal. A pedal extension is adjustably coupled to the clamp member. Horizontal movement of at least one end of the pedal extension is provided. An adjustable member is configured to selectively fix the pedal extension into a fixed position relative to the clamping member after adjustment is made.

Particular embodiments of an adjustable pedal extension device may include one or more of the following. The pedal extension may be configured for lateral horizontal movement. The pedal extension may be configured for longitudinal horizontal movement. The pedal extension may be configured for arcuate horizontal movement. The pedal extension may be configured for lateral, longitudinal and arcuate horizontal movement. The adjustable clamp member may be configured to removably couple to the piano pedal by hand without the requirement of tools.

In another aspect, a method of operating an adjustable pedal extension device may include the step of providing an adjustable pedal extension device. The method may include the step of coupling an adjustable pedal extension device to a piano through an adjustable clamping member. The method may further include the step of depressing at least one portion of an adjustable pedal extension device.

Particular embodiments of a method of operating an adjustable pedal extension device may include one or more of the following. An adjustable pedal extension device may be pivoted so that at least one portion of the adjustable pedal extension device is located under at least one piano pedal adjacent to the pedal to which the adjustable pedal extension device is coupled. At least one piano pedal adjacent to the pedal to which an adjustable pedal extension device is coupled, and under which at least a portion of the adjustable pedal extension device is located under, may be depressed so that more than one piano pedal is simultaneously engaged.

Particular embodiments of a muffler pad may include one or more of the following. The piano may include a muffler pad with gradually varying resistance. The piano may include a muffler pad with a sound effects layer.

In still another aspect, an upright piano string muffler kit may be packaged as a unit. In a particular implementation, at least two muffler pads are included; a first muffler pad and a second muffler pad different than the first.

Particular embodiments of a piano string muffler kit may include one or more of the following. A first muffler pad may include gradually varying resistance. A second muffler pad may include gradually varying resistance different than the first. A first muffler pad may include gradually varying resistance. A second muffler pad may include a sound effect layer. A first muffler pad may include a sound effect layer. A second muffler pad may include a sound effect layer different than the first. An adjustable pedal extension device may be included.

In yet another aspect, at least one muffler rail engagement stopper bumper may be placed in the travel path of a muffler rail.

The foregoing and other aspects, features, and advantages will be apparent to those of ordinary skill in the art from the DESCRIPTION and DRAWINGS, and from the CLAIMS.

### DRAWINGS

Implementations will hereinafter be described in conjunction with the appended DRAWINGS (which are not necessarily to scale), where like designations denote like elements.

FIG. 1 is a front view of an upright piano.

FIG. 2 is a front view of three piano pedals with an extension bar removably coupled to the middle pedal.

FIG. 3 is a front view of three piano pedals with an extension bar removably coupled to the middle pedal and with the extension bar extending under the left pedal.

FIG. 4 is an front view of three piano pedals, illustrating a user's foot depressing the middle pedal to which an extension bar is removably coupled.

FIG. 5 is an front view of three piano pedals, illustrating a user's foot depressing the left pedal.

FIG. 6 is a perspective view of a muffler rail with muffler pad interposed between the strings and associated hammers.

FIG. 7 is a perspective view of a muffler rail with muffler pad in a standby position, with the muffler pad not interposed between the strings and associated hammers.

FIG. 8 is a perspective view of two muffler rail stopper-bumpers.

FIG. 9 is a cross sectional view of a wedge-shaped muffler pad.

FIG. 10 is a cross sectional view of a muffler pad having a plurality of strips.

FIG. 11 is a cross sectional view of a muffler pad having a plurality of strips of gradually varying density.

FIG. 12 is a cross sectional view of a muffler pad having a plurality of strands.

### DESCRIPTION

This disclosure, its aspects and implementations, are not limited to the specific components or assembly procedures disclosed herein. Many additional components and assembly procedures known in the art consistent with the intended operation of a device for a piano and/or assembly procedures for a device for a piano will become apparent for use with particular implementations from this disclosure. Accordingly, for example, although particular implementations are disclosed, such implementations and implementing components may comprise any shape, size, style, type, model, version, measurement, configuration, material, quantity, and/or the like as is known in the art for such piano devices and implementing components, consistent with the intended operation.

### Structure

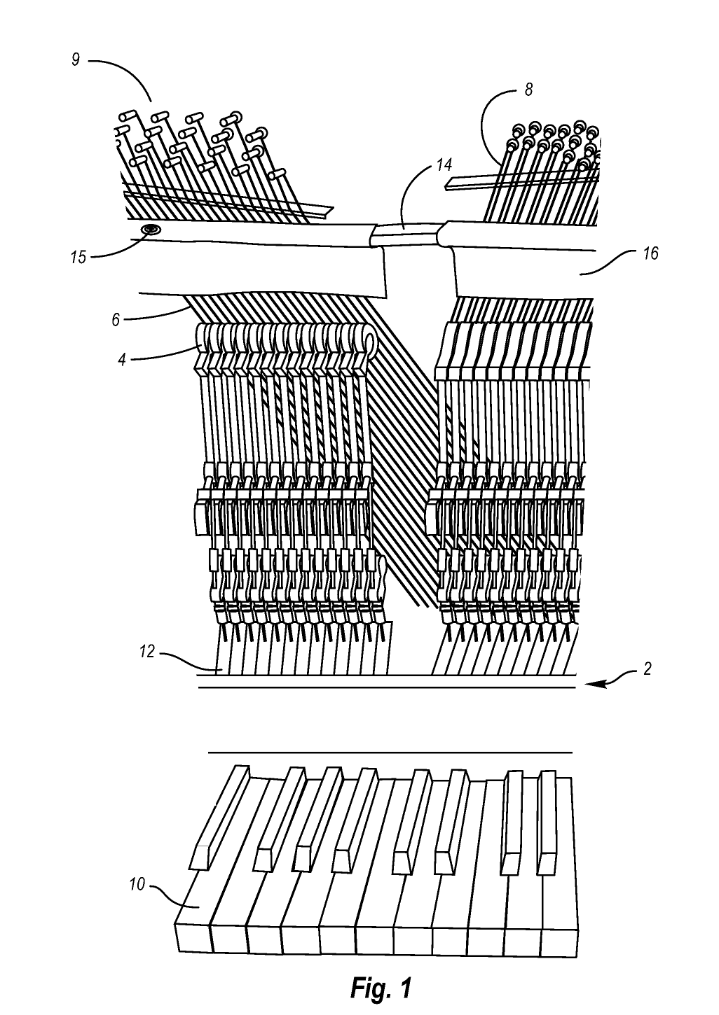

Referring to FIG. 1, a front view of an upright piano is illustrated. Piano 2 includes a plurality of hammers 4 that strike upon an associated string or strings 6 to create musical tones, notes or sounds. The associated string or strings 6 are each arranged into collections of one, two or three adjacent strings known as unisons 8 within a frame 9. Each of the plurality of hammers 4 is operated by an associated piano key 10 through a linkage assembly known as an action 12.

Referring to FIGS. 1, 6 and 7, piano 2 includes muffler rail 14 with muffler pad 16 coupled thereto. Muffler pad 16 may be coupled to muffler rail 14 with one or more clips or other fasteners 15. It will be understood by those of ordinary skill in the art from the details provided in this disclosure that the specific manner of coupling of muffler rail 16 to muffler rail 14 may be accomplished in a variety of ways and may vary according to the particular configuration of a manufacturer's muffler rail 14. Muffler rail 14 operates in conjunction with one or more muffler rail engagement elements 18, which is operationally coupled to piano pedal, hand-lever or other actuation device by one or more intermediate linkages 21. It will be understood by those of ordinary skill in the art from the details provided in this disclosure that the specific manner of engagement of muffler rail 14 may vary according to the specific configuration of the one or more intermediate linkages 21 operationally coupling muffler rail 14 to a piano pedal, hand-lever or other actuation device.

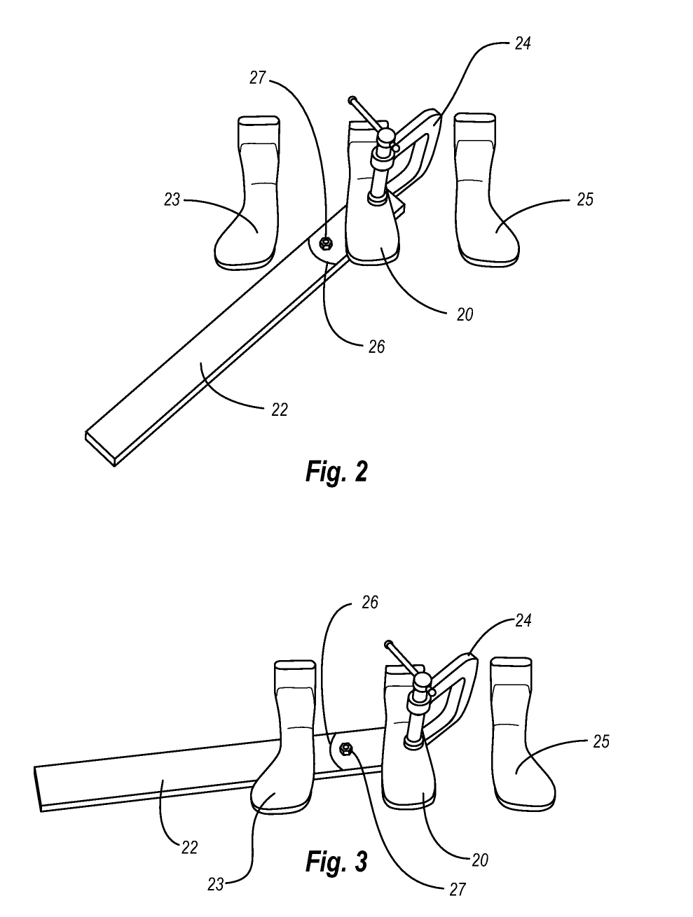

Referring to FIGS. 2 and 3, a front view of two possible positions of the extension bar 22 in relation to piano pedals 20, 23 and 25 is illustrated. Extension bar 22 may be made from rigid plastic materials such as polycarbonate, polystyrene or other plastic materials known in the art. Extension bar 22 may alternatively be made from metal, such as steel, iron, brass, zinc, magnesium, aluminum or other metals known in the art. The particular material from which the extension bar 22 is formed is not crucial, only that the extension bar 22 be made rigid. Extension bar 22 is coupled to piano pedal 20 with adjustable clamping member 24. Adjustable clamping member 24 may be made from a conventional “c” type clamp, or other clamps known in the art to rigidly couple the extension bar 22 to the pedal 20. Adjustable clamping member 24 may, in particular implementations, be integrally joined with extension bar 22. Adjustable clamping member 24 may also be removably coupled to an extension bar. Adjustable clamping member 24 may also exist as a component separate from an extension bar. Adjustable clamping member 24 may be configured so that it may be adjusted with or without the requirement of tools. For example, the c-clamp shown in FIGS. 2 and 3 includes an arm that allows a user to release the clamp by hand without the requirement of tools. In alternate implementations, the clamp may require a screw driver or wrench to release the clamp from the piano pedal. By making the pedal adjustable without the requirement of tools, however, a piano player can more easily adjust the positioning of the extension bar 22 for different songs played.

Extension bar 22 may, in particular implementations, include an adjustable member 26 to selectively fix extension bar 22 into a fixed position in relation to adjustable clamping member 24. In particular implementations, adjustable member 26 may allow extension bar 22 to be swingably positioned relative to one or more piano pedals 20, 23 and 25. In particular implementations, the adjustable member 26 may be fixed in position with a threaded screw or other fastener 27. In other particular implementations, adjustable member 26 may be configured so that it may be adjusted without the requirement of tools. For example, threaded screw 27 may comprise a knurled knob for easy grasping.

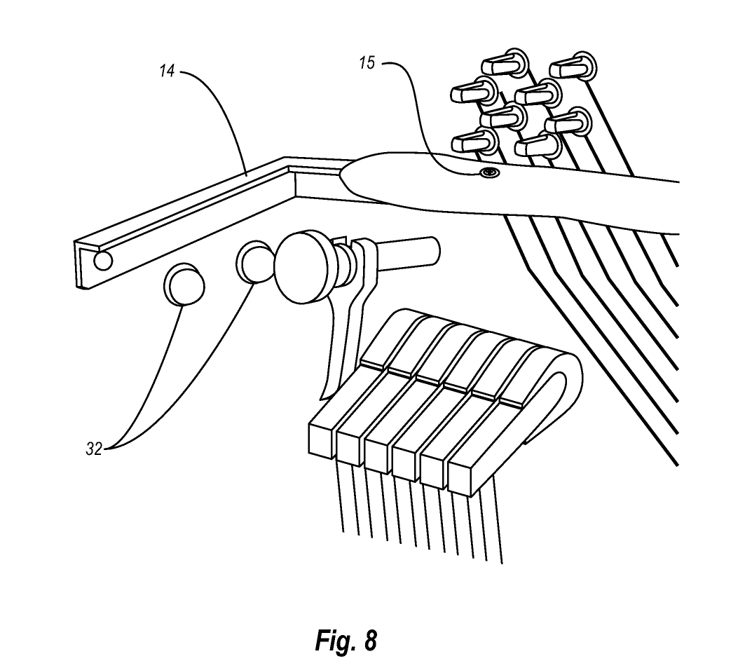

Referring to FIG. 8, a perspective view of the left side of muffler rail 14 is illustrated. Muffler rail 14 may operate in conjunction with only one or more muffler rail engagement elements 18. In those piano designs having only one muffler rail engagement element, one or more muffler rail engagement stopper bumpers 32 may be coupled to a piano 2 in the engagement travel path of muffler rail 14 on that side of muffler rail 14 lacking one or more muffler rail engagement elements 18. The one or more muffler rail engagement stopper bumpers 32, when coupled to a piano in the engagement travel path of a muffler rail 14 having fewer than desired muffler rail engagement elements 18, may reduce the bouncing or other audible vibration effects caused by activation of muffler tail 14. The one or more muffler rail engagement stopper bumpers 32 may be made from plastic materials such as polycarbonate, polystyrene, and other plastic materials known in the art, or from shock absorbent materials such as natural rubber, vulcanized rubber, synthetic rubbers, elastomers, felt, and the like. The one or more muffler rail engagement stopper bumpers 32 may be coupled with piano 2 with glue or other adhesive, may include a threaded portion that may be screwed into a pilot hole in piano 2, or may be coupled to piano 2 in any other manner known in the art.

Muffler pads having varying densities are disclosed in U.S. Pat. No. 877,603 to Irving B. Smith, issued on Jan. 28, 1908, the relevant disclosure of which is hereby incorporated herein by reference to illustrate the operation and manufacture of muffler pads in general, but in particular muffler pads having varying densities.

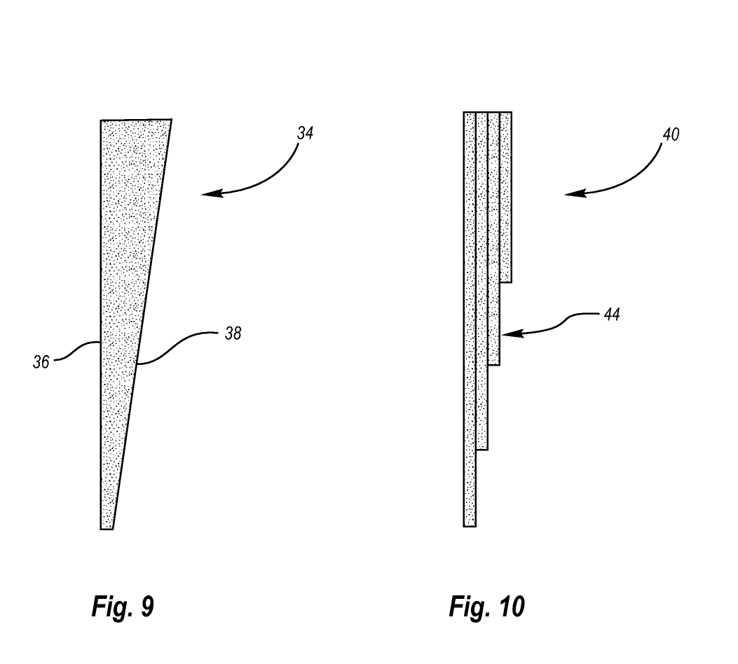

FIGS. 9-12 illustrate non-limiting examples of particular implementations of sound effects pads. Different from a conventional muffler pad, such as those disclosed in U.S. Pat. No. 877,603 to Smith, each sound effect pad 34, 40, 46 and 50 includes an additional or substitute material layer, component or thread that imparts a sound changing characteristic to the sound effect pads 34, 40, 46, and 50. A user may use sound effect pads 34, 40, 46 and 50, and other implementations thereof, interchangeably to achieve desired sound effects. Various sound effects may be created depending on the nature and characteristic of the various materials used.

By way of non limiting example, sound effect pads 34, 40, 46 and 50, and other implementations thereof, may include a layer, component or thread of film-like material such as Mylar®, Tyvek®, or other polyethylene, polystyrene, or other plastic film material. Alternatively, in order to create a different sound effect, sound effect pads 34, 40, 46 and 50, and other implementations thereof, may include a layer, component or thread of foil-like material such as tin or aluminum foil. In particular implementations, sound effect pads 34, 40, 46 and 50 may include a layer or component of woven fiberglass, Kevlar® or other aramid fibers to create yet other sound effects. In still other implementations, sound effect pads 34, 40, 46 and 50 may include a layer, component or thread of paper, parchment, Neoprene®, natural rubber, vulcanized rubber, synthetic rubbers, elastomers, and the like, or other sheet-like material to create still other sound effects. In yet other implementations, sound effect pads 34, 40, 46 and 50 may include a layer, component or thread of metal wire, nylon or plastic string, or other string-like materials to create yet other sound effects. It should be understood by those having ordinary skill in the art, that any film, foil, sheet, or string-like material may be used to create a desired sound effect. Desired sound effects may include, by way of non limiting example, percussive effects, reverberative effects, resonance effects, mimicry of naturally-occurring sounds, or any other effect to alter the conventional sound characteristic of a piano. It should be further understood by those having ordinary skill in the art that a sound effect layer, component or thread may be used in conjunction with conventional muffler pads in order to achieve simultaneous muffling and sound effects. Each of the examples provided in this paragraph when included in a sound effect pad alter the conventional sound characteristic of a piano.

Sound effect pads 34, 40, 46 and 50, and other implementations, of sound effect pads may be configured to be removably coupled to a piano muffler rail in the same manner as the prior art muffler pads. That is, a user may remove from a muffler rail an existing muffler pad and replace it with a sound effect pad such as those shown in FIGS. 9-12, or other implementations thereof in accordance with the descriptions provided herein.

Referring specifically to FIG. 9, a cross sectional view of sound effect pad 34 is illustrated. As illustrated, sound effect pad 34 may include one or more layers, components or threads of fabric such as cotton, wool, felt, linen, or other natural or synthetic fabrics. Sound effect pad 34, distinct from a conventional muffler pad, also includes one or more layers, components or threads of film, foil, sheet, or string-like material, described above, to alter the conventional sound characteristic of a piano. Sound effect pad 34 is wedge-shaped in cross section and includes one straight face 36 and one inclined face 38. Either, or both of, straight face 36 and inclined face 38 may include an additional sound effect layer, component or thread according to the description above. Alternatively, a sound effect layer, component or thread may be included within sound effect pad 34, that is, between straight face 36 and inclined face 38. In other particular implementations, the sound effect pad 34 may be made entirely of a plastic or metal material having a wedge shape. Although the wedge shape is shown here with a drastic slope on the inclined face 38 to emphasize that the thickness changes, it is contemplated that the thickest portion on some implementations may be only thousandths of an inch thick. In other words, FIGS. 9-12 are not necessarily drawn proportionally to every implementation.

Referring to FIG. 10, a cross sectional view of another particular implementation of a sound effect pad 40 is illustrated. Sound effect pad 40 may include one or more strips of fabric such as cotton, wool, felt, linen, or other natural or synthetic fabrics. Sound effect pad 40, distinct from a conventional muffler pad, also includes one or more layers, components or threads of film, foil, sheet, or string-like material, described above, to alter the conventional sound characteristic of a piano. As illustrated, the one or more strips included in sound effect pad 40 may be arranged in a manner of gradually decreasing length so as to provide on one side a series of stepped faces 44. Each strip in sound effect pad 40 may be made of the same, or different, material than the other strips in sound effect pad 40. In particular implementations, all the strips may be sound effect strips including layers, components or threads of film, foil, sheet, or string-like material as described above. In other implementations, some of the strips may be conventional-type muffler material and other strips may be sound effect strips including layers, components or threads of film, foil, sheet, or string-like material as described above. It will be understood by those having ordinary skill in the art that sound effect strips may be arranged in any manner in order to achieve a desired sound effect. It will be understood by those having ordinary skill in the art that the series of stepped faces 44 in sound effect pad 40 may allow multiple sound effects since the greater the number of layers that are used, the greater the number of effects that may be achieved. In particular implementations, each strip is made of a different sound effect material to give a different sound effect with each level of the sound effect pad 40.

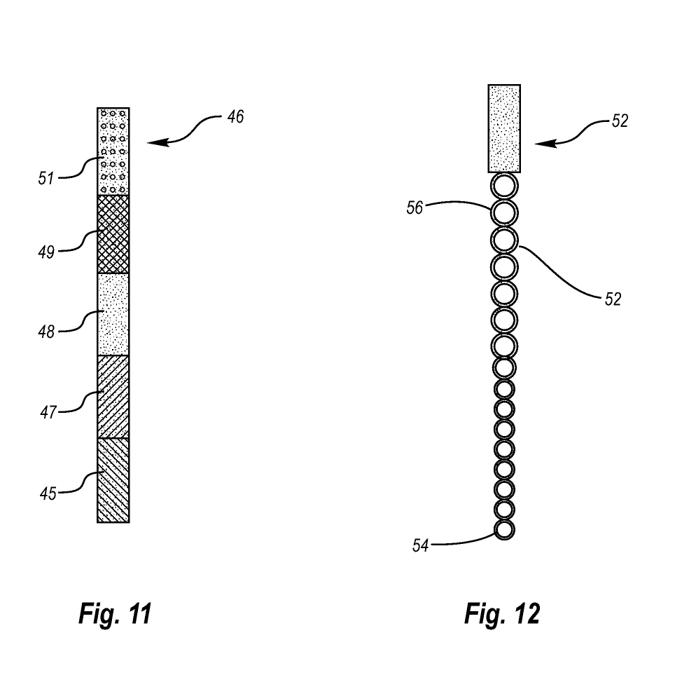

Referring to FIG. 11, a cross sectional view of a sound effect pad 46 is illustrated. Sound effect pad 46 may include one or more strips of fabric such as cotton, wool, felt, linen, or other natural or synthetic fabrics. Sound effect pad 46, distinct from a conventional muffler pad, also includes one or more layers, components or threads of film, foil, sheet, or string-like material, described above, to alter the conventional sound characteristic of a piano. As illustrated, the sound effect pad 46 includes a plurality of sections 45, 47, 48, 49. Each of the plurality of sections 45, 47, 48 and 49 may include the same, or different, sound effect layers, components or threads of film, foil, sheet, or string-like material as described above. In particular implementations, all the sections may include sound effect layers, components or threads of film, foil, sheet, or string-like material as described above. In other implementations, some of the sections may be conventional-type muffler material and other sections may be sound effect sections including layers, components or threads of film, foil, sheet, or string-like material as described above. The plurality of sections 48 may likewise be formed as a single piece, or may be formed of separate pieces and integrally joined together. It will be understood by those having ordinary skill in the art that the plurality of sections 48 in sound effect pad 46 may allow multiple sound effects changes since the greater the number of sections used, the greater the number of sound effects that may be achieved.

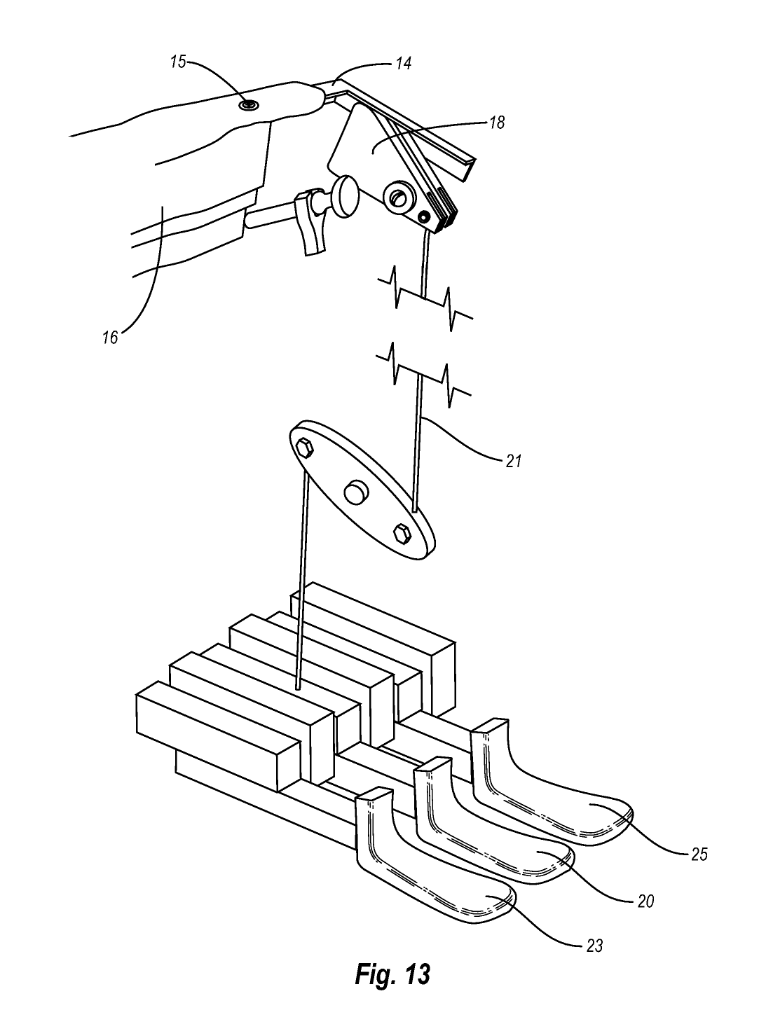

Referring to FIG. 12, a cross sectional view of sound effect pad 50 is illustrated. As illustrated, the sound effect pad may include a plurality of strands 52 of fiber such as cotton, wool, felt, linen, or other natural or synthetic fibers. Sound effect pad 50, distinct from a conventional muffler pad, also include one or more layers, components or threads of film, foil, sheet, or string-like material, described above, to alter the conventional sound characteristic of a piano. Each of the plurality of sections 52 may be made from the same layers, components or threads of film, foil, sheet, or string-like material, described above, or they may include different layers, components or threads of film, foil, sheet, or string-like material. In particular implementations, all the sections may include sound effect layers, components or threads of film, foil, sheet, or string-like material as described above. In other implementations, some of the sections may be conventional-type muffler material and other sections may be sound effect sections including layers, components or threads of film, foil, sheet, or string-like material as described above. The section of sound effect pad 50 formed by the smaller strands 54 is located at the bottom of the sound effect pad 50, and the section of sound effect pad 50 formed by the larger strands 56 is located at the top of the sound effect pad 50. It will be understood by those having ordinary skill in the art that the plurality of strands 52 in sound effect pad 50 may allow multiple sound effects since the greater the number of strands used, the greater the number of effects that may be achieved

### Use

Referring to FIG. 1, the operation of piano 2 will be described. When piano key 10 is depressed, a linkage assembly known as an action 12 is engaged which, in turn, activates one of a plurality of hammers 4 that is associated with a given key 10 and action 12. Once activated, a hammer 4 strikes upon an associated string or strings 6 to create musical tones, notes or sounds.

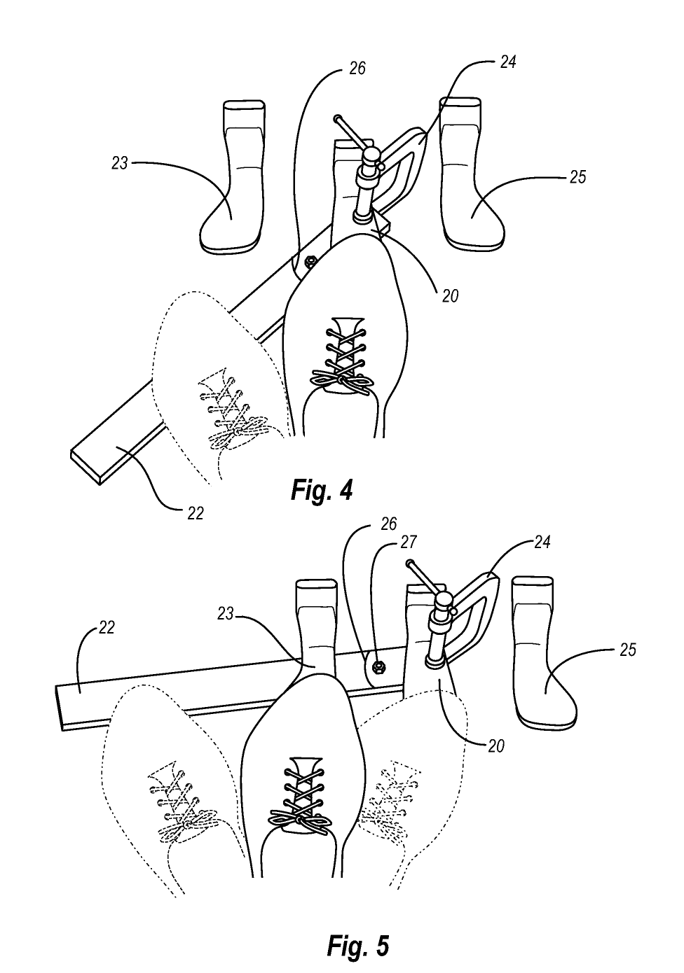

Referring to FIG. 4, the operation of piano pedal 20 with extension bar 22 coupled thereto, is illustrated. After extension bar 22 is coupled to piano pedal 20 by a user, with the aid of adjustable clamping member 24, a user may adjust adjustable member 26 to selectively fix extension bar 22 into a fixed position in relation to adjustable clamping member 24. A user may thereafter engage piano pedal 20 by directly depressing piano pedal 20. A user may alternatively engage piano pedal 20 to which extension bar 22 is coupled by depressing one or more portions of extension bar 22.

Referring to FIG. 5, the operation of piano pedal 20 with extension bar 22 coupled thereto, is illustrated. After extension bar 22 is coupled to piano pedal 20 by a user, with the aid of adjustable clamping member 30, a user may adjust an adjustable member 26 to selectively fix extension bar 22 into a fixed position in relation to adjustable clamping member 30. A user may alternatively selectively adjust adjustable member 26 so that distal end 29 is located under piano pedal 23 adjacent to piano pedal 20 to which the extension bar 22 is coupled. In this manner, a user may engage piano pedal 20 by directly depressing the piano pedal 20. A user may alternatively engage piano pedal 20 by depressing distal end 29 of extension bar 22. Alternatively, with distal end 29 fixed in position under piano pedal 23, a user may simultaneously engage piano pedal 23 and piano pedal 20 by depressing only piano pedal 23 since the depression of pedal 23 in this arrangement may engage distal portion 29 of extension bar 22 which is coupled to piano pedal 20.

At least one end of extension bar 22 may be configured for horizontal movement through adjustable member 26. Horizontal movement includes movement that is on a plane substantially parallel to horizontally extending piano pedals 20, 23 and 25. At least one end of extension bar 22 may be configured for lateral horizontal movement through adjustable member 26. Lateral horizontal movement includes movement that is side-to-side and on a plane substantially parallel to horizontally extending piano pedals 20, 23 and 25. For example, a player moving an end of extension bar 22 from piano pedal 20 to piano pedal 23, would be making a lateral horizontal movement. At least one end of extension bar 22 may be configured for longitudinal horizontal movement through adjustable member 26. Longitudinal horizontal movement includes movement that is in-and-out and on a plane substantially parallel to horizontally extending piano pedals 20, 23 and 25. For example, a player moving extension bar 22 from piano pedal 20 towards the user, would be making a longitudinal horizontal movement. At least one end of extension bar 22 may be configured for arcuate horizontal movement through adjustable member 26 Arcuate horizontal movement includes movement that follows a curved path and on a plane substantially parallel to horizontally extending piano pedals 20, 23 and 25. For example, a player moving an end of the extension bar 22 in an arc from piano pedal 20 to piano pedal 23, would be making an arcuate horizontal movement.

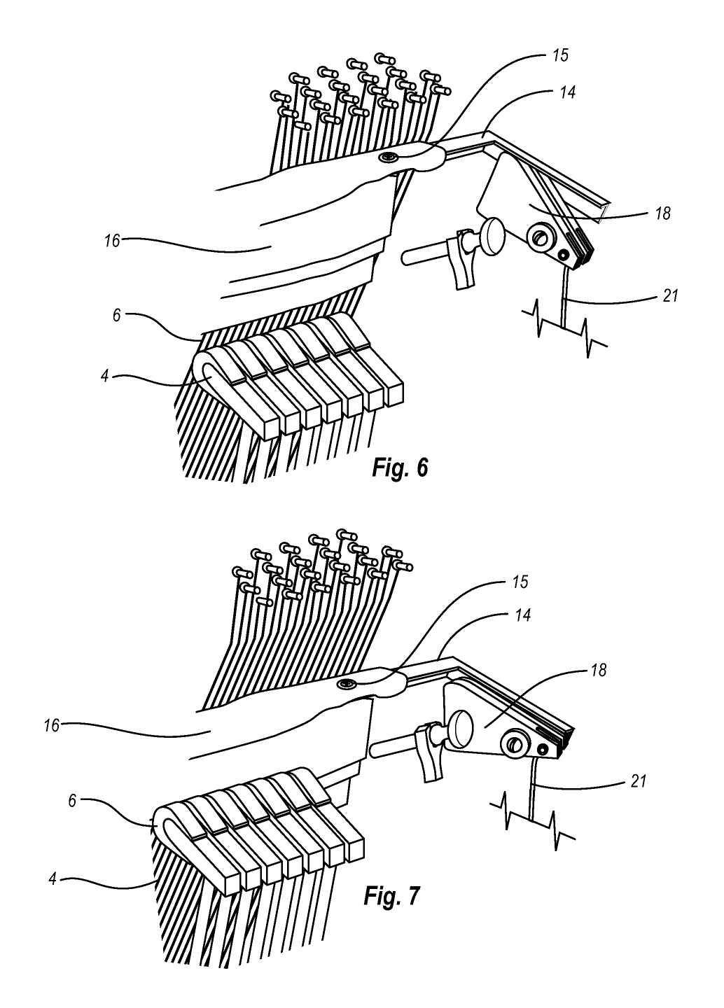

Referring to FIGS. 1 and 6, the operation of muffler rail 14 with muffler pad 16 coupled thereto will be described. Muffler rail 14 operates in conjunction with one or more muffler rail engagement elements 18, which is operationally coupled to a piano pedal, hand-lever or other actuation device by one or more intermediate linkages 21. FIG. 6 illustrates that during normal piano performance, a pad 16 (or whether a muffler pad or a sound effect pad) coupled to a muffler rail 14 is maintained in a standby position clear of the plurality of hammers 4 and the associated string or strings 6.

Referring to FIGS. 1, 7 and 13, the operation of muffler rail 14 with pad 16 coupled thereto will be further described. When piano pedal 20 operationally coupled to muffler rail 14 by one or more intermediate linkages 21 is depressed by a user, muffler rail 14 is engaged. It will be understood that the specific engagement of a muffler rail 14 may vary according to the specific configuration of the one or more intermediate linkages 21 operationally coupling muffler rail 14 to piano pedal 20. When muffler rail 14 is thus engaged, pad 16 coupled to a muffler rail 14 becomes interposed between the plurality of hammers 4 and the associated string or strings 6. When a user depresses piano key 10 with muffler rail 14 engaged so that pad 16 coupled to muffler rail 14 is interposed between the plurality of hammers 4 and the associated string or strings 6, the hammer 4 associated with the given piano key 10 will be prevented from directly striking the associated string or strings 6, resulting in a comparatively lower tonal volume. It will be understood that the further piano pedal 20 is depressed by a user, the further the muffler rail 14 may be engaged. It follows then, that the further muffler rail 14 is engaged, the greater the portion of the muffler pad 16 that will be interposed between the hammer 4 and associated string or strings 6. It will be understood by those having ordinary skill in the art that when a sound effect pad, as described above and illustrated in FIGS. 9-12, is coupled to a muffler rail 14, it is the sound effect pad that will be interposed between the hammer 4 and associated string or strings 6.

Referring to FIGS. 8 and 13, the operation of one or more muffler rail engagement stopper bumpers 32 is illustrated. When piano pedal 20, operationally coupled to muffler rail 14 by one or more intermediate linkages 21, is depressed by a user, muffler rail 14 is engaged. Where muffler rail 14 is engaged in conjunction with only a single muffler rail engagement element 18 on a side so that it lacks one or more conventional muffler rail engagement elements 18, one or more muffler rail engagement stopper bumpers 32 may be placed in the path of engagement travel of the side of muffler rail 14. In this arrangement, the side of muffler rail 14 lacking one or more muffler rail engagement elements 18 may make contact with the one or more muffler rail engagement stopper bumpers 32 which may reduce the bouncing or other vibration effects caused by activation of muffler rail 14 with fewer than desired muffler rail engagement elements 18.

While the invention has been particularly shown and described with reference to embodiments thereof, it will be understood by those skilled in the art that various changes in form and details may be made therein without departing from the spirit and scope of the invention. Accordingly, unless otherwise specified, any components of the devices and methods to assist in playing a piano according to the present invention indicated in the drawings or herein are given as an example of possible components and not as a limitation. Similarly, unless otherwise specified, any steps or sequence steps of the methods according to the present invention indicated herein are given as examples of possible steps or sequence of steps and not as limitations.

1. An adjustable pedal extension device for a multiple pedal piano, the extension device comprising:
an adjustable clamp member configured to receive and couple to a piano pedal; and
a pedal extension adjustably coupled to the clamp member for horizontal movement of at least one end of the pedal extension through an adjustable member;
wherein the adjustable member is configured to selectively fix the pedal extension into a fixed position in relation to the adjustable clamp member after adjustment is made.

2. The adjustable pedal extension device of claim 1, wherein the adjustable pedal member is configured for lateral horizontal movement.

3. The adjustable pedal extension device of claim 1, wherein the adjustable pedal member is configured for longitudinal horizontal movement.

4. The adjustable pedal extension device of claim 1, wherein the adjustable pedal member is configured for arcuate horizontal movement.

5. The adjustable pedal extension device of claim 1, wherein the adjustable pedal member is configured for lateral, longitudinal and arcuate movement.

6. The adjustable pedal extension device of claim 1, wherein the clamp member is further configured to removably couple to the piano pedal by hand without the requirement of tools for selective coupling and removal by a user while playing the piano.

7. A method of operating an adjustable pedal extension device, the method comprising:
providing an adjustable pedal extension device;
coupling the adjustable pedal extension device to a piano pedal through and adjustable clamping member;
depressing at least one portion of the adjustable pedal extension device.

8. The method of claim 7, wherein coupling comprises:
pivoting an adjustable pedal extension device so that at least one portion of the adjustable pedal extension device is located under at least one adjacent pedal.

9. The method of claim 8, further comprising depressing at least one piano pedal adjacent to a piano pedal to which an adjustable pedal extension device is coupled so that more than one piano pedals are simultaneously engaged.

10. The method of claim 8, further comprising depressing at least one piano pedal adjacent to a piano pedal to which an adjustable pedal extension device is coupled so that at least two piano pedals are simultaneously engaged.

11. A piano muffler kit packaged as a unit, having at least two piano muffler pads comprising:
a first piano pad; and
a second piano pad configured as a sound effect pad.

12. The piano muffler kit of claim 11, wherein the first piano pad is a muffler pad of gradually varying resistance and the sound effect pad comprises at least one sound effect layer.

13. The piano muffler kit of claim 11, wherein the first piano pad is a first sound effect pad configured to alter a tonal quality of a piano sound in a first way and the second piano pad is a second sound effect pad configured to alter the tonal quality of the piano sound in a second way different from the first way.

14. The piano muffler kit of claim 11, wherein the sound effect pad comprises at least one layer of a film material positioned on the pad to be against strings of the piano when installed.

15. The piano muffler kit of claim 11, further comprising:
an adjustable pedal extension device.

16. A method of reducing audible muffler rail vibration in pianos having a single muffler rail engagement element, the method comprising:
identifying the engagement travel path of a muffler rail;
coupling one or more muffler rail engagement stopper bumpers to a piano in the engagement travel path of a piano muffler rail.
